(19) United States
(12) Patent Application Publication
(10) Pub. No.: US 2004/0264075 A1
(43) Pub. Date: Dec. 30, 2004

(54) Steering assist system

(75) Inventor: Sergei F. Kolomeitsev, Rochester, MI (US)

Correspondence Address: MATTHEW R. JENKINS, ESQ., 2310 FAR HILLS BUILDING, DAYTON, OH, 45419, US

(73) Assignee: VALEO ELECTRICAL SYSTEMS, INC.

(21) Appl. No.: 10/609,893

(22) Filed: Jun. 30, 2003

(51) Int. Cl. H02H 7/08

(52) U.S. Cl. 361/23

(57) ABSTRACT

An automotive steering assist system having an electric motor provided with poles organized into 2 groups. The motor has means for detecting shorts in the poles and means for disabling all poles in a pole group whenever a short is detected in a pole of that group.

### BACKGROUND OF THE INVENTION

This invention relates to automobiles and more particularly to an electric power steering system for use in an automobile. Generally speaking, power steering systems do not perform the entire job of steering an automobile. Steering of an automobile is so critically important that the operator of the automobile is placed in full time, hands on control. Power steering systems generally sense the operator's steering efforts and supplement them with mechanically generated torque, usually provided by an electrically powered steering motor. Therefore power steering systems are more properly called “power assisted” steering systems. These systems generally have an automatic controller for adjusting the output of the steering motor in accordance with a control algorithm which takes most of the effort out of the operator's task, while providing an overall steering response having a comfortable “feel.”

Power steering systems are designed for fail-safe operation. That is, failures in the power steering system are forced to happen in such a way as to avoid creation of a safety hazard. This usually mandates natural shutdown of the steering motor upon occurrence of a serious steering system failure. The event leaves the operator in full control, albeit faced with a post-failure task requiring a greatly increased amount of manual effort.

One of the difficulties encountered by an electric power assisted steering system arises from the use therein of high torque brushless DC motors having wound stators and permanent magnet rotors. When a motor of that particular type is installed in a steering assist system there is a risk of an electrical short at some time over the life of the motor. In such a case the power steering may actually create a torque acting contrary to the efforts of the operator, thereby making it difficult for the drive to overcome the breaking torque. It all depends upon the nature of the short. There are two common solutions to the problem:

1. Placing a mechanical clutch between the motor output and the steering mechanism to disconnect the failed motor from the steering function.

2. Placing a relay in the motor (or in a controller associated with the motor), at the wye connection center point, and using the relay to disconnect the motor windings from their power source, upon occurrence of the short.

3. When a relay is situated in the controller, separate lead conductors to each coil are required. This means that six (6) leads are required if the relay is situated in the controller, as opposed to three when the relay is situated at the wye connection center point.

Another difficulty with relays situated or installed in the motor is temperature. A typical relay has a temperature operating limit of approximately 125 degrees Fahrenheit, which necessarily limits the maximum temperature at which the motor can operate.

Likewise, if the relay is situated in the controller, two further disadvantages may occur. First, and as mentioned above, additional wires or conductors are required to connect the relay to the wye connection.

Second, the temperature limits of the relay also limits the operating temperature of the controller.

Consequently, there is a need for an arrangement that eliminates the need for use of a relay and the limitations that come with it.

None of these solutions is entirely satisfactory. The clutch introduces substantial additional cost into the steering assist system and limits form and fit options available to the designer. The relay increases effective motor phase resistance, reduces motor efficiency and torque at a given rotational speed and requires additional space under the hood.

### SUMMARY OF THE INVENTION

This invention reduces-the risk of harm, resulting from a short in a brushless permanent magnet motor by forming two m-phase winding groups and connecting them to two separate control modules. In the event of either a turn-to-turn short or a phase-to-phase short, the control module for the impacted phase group is disabled. The healthy phase group remains in full operation and generates a torque in a direction for offsetting the braking torque of the infected phase group and also provides some power steering assist.

### BRIEF DESCRIPTION OF THE DRAWINGS

FIG. 1 illustrates control connections for a stator of a steering assist system;

FIG. 2 is an equivalent circuit diagram for a steering assist system;

FIG. 3 is a plot showing the torque generated by a three-phase group in a first instance wherein two phases are shorted together and a second instance wherein all three phases are shorted together; and

FIG. 4 illustrates a steering assist system in an alternative embodiment.

### DETAILED DESCRIPTION

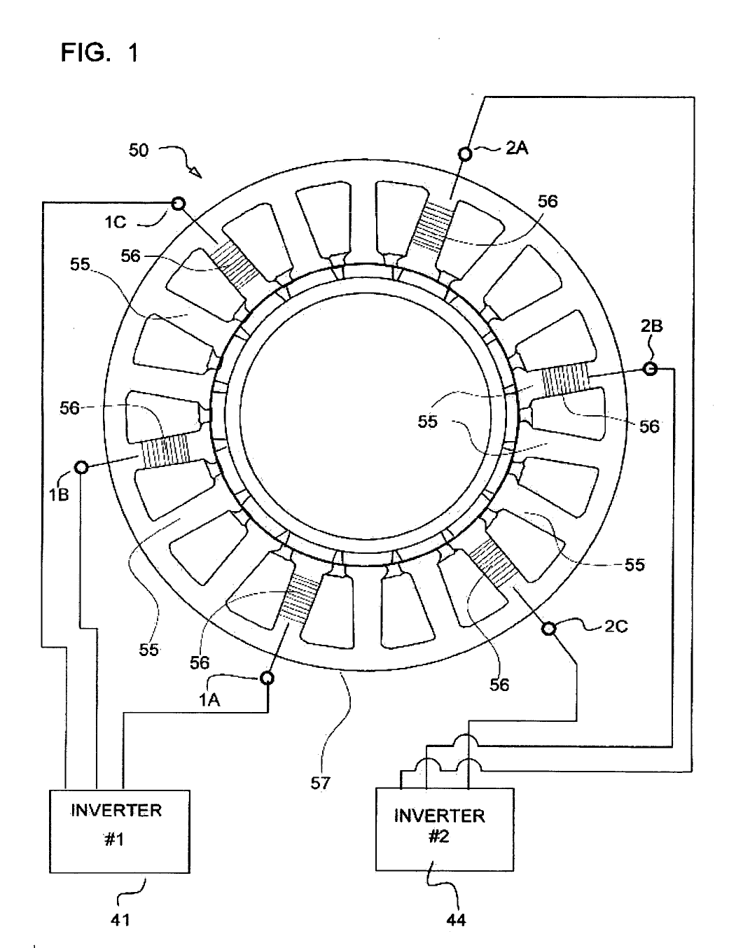

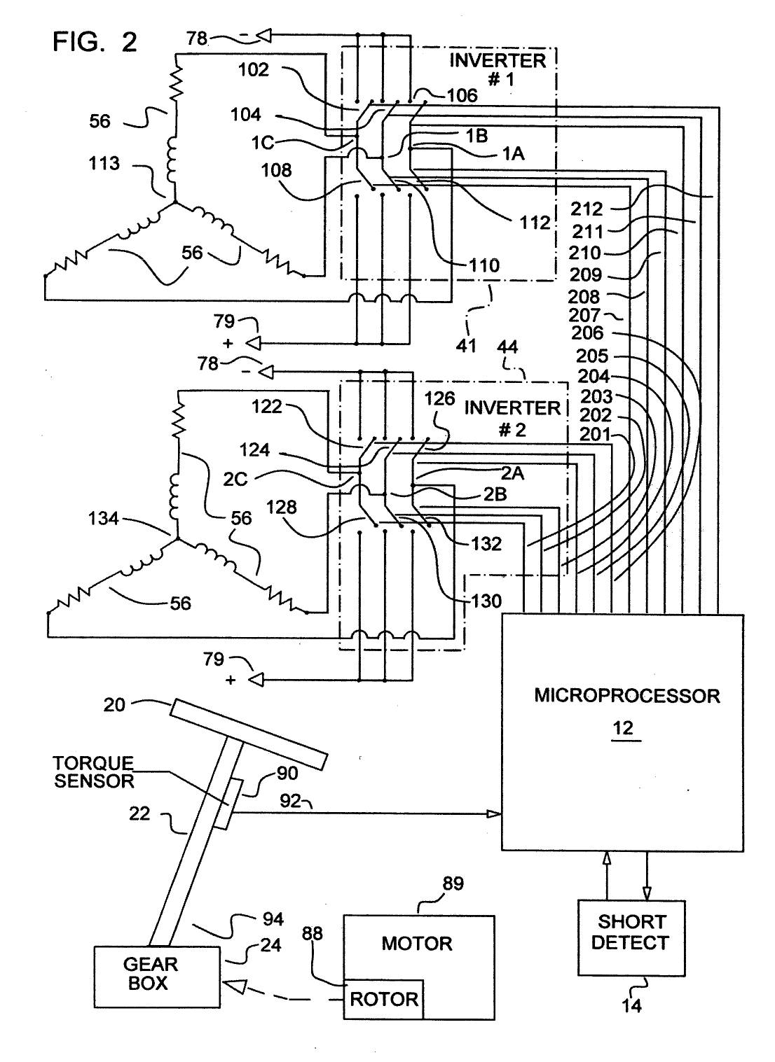

A steering assist system, according to the present invention, utilizes a brushless DC motor 89 (FIG. 2) having a wound pole stator 50 and a permanent magnet rotor 88. Higher torque brushless magnet motors usually have several pole pairs. A preferred embodiment of the invention, as illustrated in FIGS. 1 and 2, has a brushless permanent magnet motor 89 equipped with a stator having six wound poles grouped into two groups of three poles each. The spacing is such that there is little or no magnetic coupling between the two pole groups. The two pole groups are controlled separately by inverters 41 and 44 under the management of a common microprocessor 12. In the illustrated embodiment six poles 56, are circularly arranged at 60 deg. intervals within stator 50. Stator 50 runs on three-phase alternating current, generated by two inverters 41, 44, connected to a current source of negative polarity 78 and also to a current source of positive polarity 79, all organized as illustrated by the schematic diagram of FIG. 2.

The illustrated embodiment provides two torque assist channels. A first torque assist channel is defined by six switching control lines 207-212, first inverter 41, three terminals 1A, 1B, 1C and three wye-connected poles 56 meeting at a null point 113. A second torque assist channel is similarly defined by six switching control lines 201-206, second inverter 44, three terminals 2A, 2B, 2C and three wye-connected poles 56 meeting at a null point 134connected for receiving three phases of current from inverter 44 via three terminals 2A, 2B, 2C.

Stator 50 has a disk-like support structure 57, featuring eighteen radially extending, spokes 55. Poles 56 are assembled by winding suitable insulated wire around spokes 55. Inverters 41,44 supply pulses of electrical current from source 79 and sink 78 to poles 56 for creation of electrical fields, which in turn produce torque in rotor 88 by reaction with permanent magnets (not illustrated) mounted thereon. These pulses occur at a fixed frequency and have a fixed amplitude. They are width-modulated so as to have cyclic average values of just the right amount to produce the supplemental torque being demanded by microprocessor 12. The pulse generation frequency is sufficiently high, relative to the motor speed, that the pulse train appears the same as a signal having a continuously varying amplitude of the same average power. Such pulse width modulation is well known. A teaching thereof may be found in Miliner et al. U.S. Pat. No. 5,428,522, which is incorporated herein by reference and made a part hereof.

As shown in FIG. 2, three poles 56 of the first torque assist channel are tied together to create a wye connection having a null point 113. in like manner three poles 56 of the second torque assist channel are tied together to create a wye connection having a null point 134. Poles 56 of the first torque assist channel extend from null point 113 to terminals 1A, 1B, 1C, and poles 56 of the second torque assist channel similarly extend from null point 134 to terminals 2A, 2B, 2C. First inverter 41 supplies stator 57 with a first 3-phase driving signal via terminals 1A, 1B, 1C, while second inverter 44 supplies stator 57 with a second 3-phase driving signal via terminals 2A, 2B, 2C. Inverters 41, 44 are identical in construction, and therefore only inverter 41 will be described. Reference numeral correspondence is readily apparent by reference to FIG. 2.

Inverter 41 has six switches 102, 104, 106, 108, 110, 112. Preferably these switches are MOSFET transistors that are switched ON and OFF by binary codes downloaded from microprocessor 12 onto transmission lines 207-212. More particularly, the states of switches 102, 104, 106 are controlled by transmission lines 212, 211, 210 respectively, while the states of switches 108, 110, 112 are controlled by transmission lines 207, 208, 209 respectively. These switches are arranged for bi-directional current flow through poles 56.

When switches 102, 104, 106 are closed, 3-phase current flows from null point 113 outwardly to terminal points 1C, 1B, 1A, and then passes through switches 102, 104, 106 into sink 78. When switches 108, 110, 112 are closed, opened, 3-phase current flows from source 79 through switches 108, 110, 112 and terminals 2A, 2B, 2C to null point 113. There is no flow of current between source 79 and sink 78, so switches in the pair 102, 108 are never closed simultaneously. To do so would create a short between sink 78 and source 79. Likewise, there is no simultaneous closure of switches in the switch pair 104, 110 or the pair 106, 112. In order to guard against such a catastrophic occurrence, all switches in Inverter #1 (and inverter #2, as well) should fail safely to the open position. Channel 1 delivers clockwise supplemental torque for current flow in one direction through poles 56 and counter clockwise for current flow the reverse direction.

In the steering assist system of the embodiment described, the operator applies torque to a steering wheel 20 which, as mentioned earlier, is sensed by torque sensor 90 and fed to microprocessor 12. The microprocessor 12, in turn, closes one or more of the switches 102-110 for inverter 1 and switches 122-132 for inverter 2 to provide the desired motor torque output to provide the desired steering assist. This produces twisting and turning of steering column 22. The twisting is proportional to the torque applied to steering column 22 by the operator. That torque is measured by torque sensor 90 for generation of a torque feedback signal applied to a line 92, connected to microprocessor 12. As the steering wheel turns, torque sensor 90 generates a torque signal, which is applied to a line 92 and routed to microprocessor 12. Microprocessor 12 is programmed to generate steering assist commands responsive to the torque signal and to download those commands on transmission lines 201-212 to provide steering assist.

There is a short detector 14 connected to microprocessor 12 for detecting wire shorts within the system. Upon detection of a snort, microprocessor 12 executes a diagnostic routine for identifying the nature of the short and determining the torque assist channel within which it is located. Suitable diagnostic routines are well known and need not be described herein, see, for example, Kushion U.S. Pat. No. 6,271,637 B1 or Bowers et al. U.S. Pat. No. 6,529,135 B1, which are incorporated herein by reference and made a part hereof.

In accordance with this invention, microprocessor 12 is programmed to shut down the current to all three poles within the affected channel upon detection of a short. For instance, if a short is experienced between poles 56 associated with terminals 1A and 1B, then all of the switches 102, 104, 106, 108, 110 and 112 are opened. This effectively halves the torque assist provided by the steering motor 89 but it substantially removes the erratic fluctuation experienced by the operator.

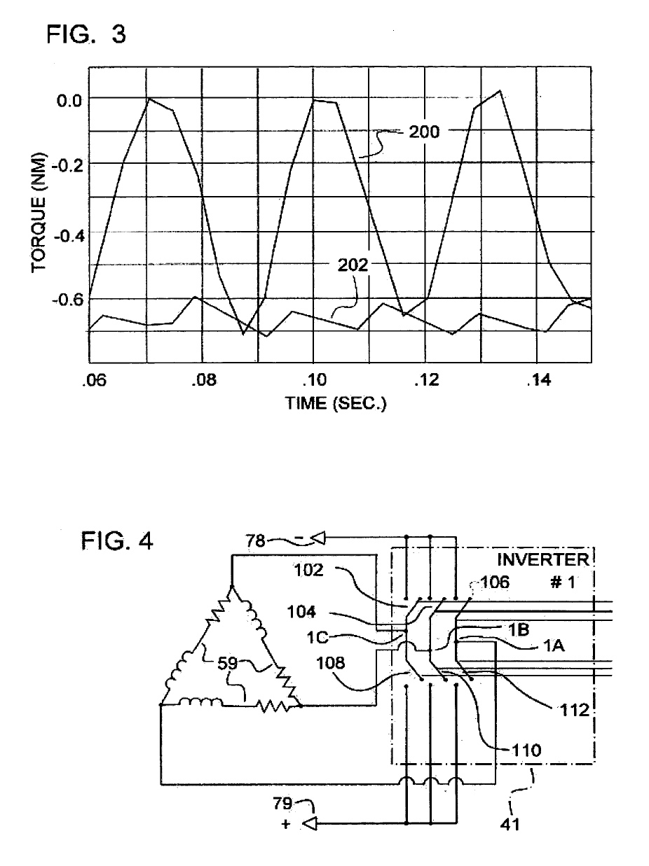

Alternatively, inverter #1 could respond to a short in its pole group by closing switches 102, 104, and 106, while simultaneously opening switches 108, 110 and 112. This would create a short to the negative side of the DC power supply. A reversal of all six switch positions would create a short to the positive side of the power. Any of these three switching schemes would result is a reduced but less erratic torque profile as indicated by line 202 of FIG. 3.

FIG. 3 is a torque/time plot showing calculated benefits of the invention. The figure shows a first line 200 which illustrates the erratic variations in torque which accompany a short between wire turns in different poles 56 within the same torque assist channel. It is clear that such torque variations create a difficult steering problem for an operator. The operator not only loses the benefit of the torque expected from the failed poles but also faces the task of providing manual torques for compensating the erratic variations then occurring. Line 202 of FIG. 3 illustrates the torque generated by the steering assist system after the affected torque assist channel has been disabled. If, for example, a short occurs in one of the phases of inverter 1 in FIG. 1, then microprocessor 12 detects the failure (i.e., the short) and places switches 102, 104, 106, 108, 110, and 112 into one of the three switching configurations described above, the all-switch-open configuration being most highly preferred.

After the microprocessor 12 disables all phases in the group, the torques/time curve 202 is achieved. This, in turn, enables the system to overcome the braking torque illustrated by the peaks of curve 200, which occurs if microprocessor does not compensate or adjust for the torque. Thus, microprocessor 12 facilitates overcoming the braking torque and operates with the remaining healthy channel associated with inverter 2 in FIG. 1. While the operator has lost a substantial amount of the previously supplemental torque, a good part still remains available and the erratic fluctuations are gone.

FIG. 4 illustrates an alternate embodiment substantially similar to the above described embodiment, differing therefrom only in the use of poles 59 arranged in a delta configuration as opposed to the wye configuration of poles 56. The performance of the alternative embodiment of FIG. 4 should be substantially the same as that of the above described preferred embodiment.

While the forms of apparatus herein described constitute preferred embodiments of the invention, it is to be understood that the invention is not limited to these precise forms of apparatus and that changes may be made therein without departing from the scope of the invention defined by the following claims.

What is claimed is:

1. In an automotive steering assist system comprising a DC motor having a permanent magnet rotor and a stator including 2 m poles subject to shorts, the improvement wherein said poles are organized into first and second m-phase groups, said automotive steering assist system further comprising: means for detecting a short in any of said poles, and means for disabling all of said poles within the m-phase group of a shorted pole which has been so detected.

2. An automotive steering assist system improvement according to claim 1 wherein m=3.

3. An automotive steering assist system improvement according to claim 2 wherein all of said poles within any said pole group are wye connected at a null point.

4. An automotive steering assist system improvement according to claim 1, further comprising means for delivering pulse width modulated driving signals to said poles.

5. An automotive steering assist system improvement according to claim 4 wherein said motor comprises a permanent magnet rotor and a wire-wound stator, said stator having a generally circular cross-section and being wound to define six radially extending poles, which are circularly positioned at regular 60 degree intervals.

6. An automotive steering assist system according to claim 5 wherein said stator is provided with eighteen radially extending spokes, circularly positioned at regular 20 degree intervals, said poles being wound on every third one of said spokes.

7. An automotive steering assist system improvement according to claim 5 wherein said first m-phase group comprises three adjacent ones of said poles, and said second m-phase group comprises three of said poles, diametrically opposing said poles of said first m-phase group.

8. An automotive steering assist system improvement according to claim 5, further comprising means for delivering pulse width modulated driving signals to said poles.

9. An automotive steering assist system improvement according to claim 3, further comprising means for delivering pulse width modulated driving signals to said poles.

10. An automotive steering assist system improvement according to claim 9 wherein said means for delivering pulse width modulated driving signals to said poles comprises:
(a) a DC power source;
(b) a DC power sink;
(c) computing means for generating pulse-width modulated command signal
(c) a pair of inverters of like construction, each comprising: a set of switches connected for directing a flow of current between one of said 3-phase groups of poles and either said DC power source or said DC power sink, the direction of said flow of current being toggled in accordance with the binary state of said pulse-width modulated command signal.

11. In a motor vehicle steering system having a manually operated steering wheel and direction control apparatus responsive to rotational movement of said steering wheel by causing a directional change of said motor vehicle, steering assistance apparatus comprising;
(a) first sensor for generating a first sensing signal indicative of torque being applied to said steering wheel;
(b) a second sensor for generating a second sensing signal indicative of a rotational position of said steering wheel;
(c) computing apparatus programmed to read said first and second sensing signals , and to generate torque assist command signals therefrom, said torque assist command signals being directed into two separate, m-phase, torque assist channels;
(d) a motor having a permanent magnet rotor and a wire wound stator; said stator being provided with 2 groups of m-phase wire wound poles, the poles in each of said pole groups being connected for receiving torque assist commands transmitted by one of said torque assist channels, and able to generate the corresponding torques; and
(e) a short detector for appraising said computing apparatus concerning the existence of shorts in said stator, said computer being programmed to generate control signals which switch off current to the windings of all poles within any channel in which a short has been detected.

12. Steering assistance apparatus according to claim 11 wherein m=3.

13. An automotive steering assist system improvement according to claim 2 wherein all of said poles within any said pole group are wye connected at a null point.

14. An automotive steering assist system improvement according to claim 13, further comprising means for delivering pulse width modulated driving signals to said poles.

15. An automotive steering assist system improvement according to claim 14 wherein said motor comprises a permanent magnet rotor and a wire-wound stator, said stator having a generally circular cross-section and being wound to define six radially extending poles, which are circularly positioned at regular 60 degree intervals.

16. An automotive steering assist system improvement according to claim 15 wherein said stator is provided with eighteen radially extending spokes, circularly positioned at regular 20 degree intervals, said poles being wound on every third one of said spokes.

17. An automotive steering assist system improvement according to claim 15 wherein said first m-phase group comprises three adjacent ones of said poles, and said second m-phase group comprises three of said poles, diametrically opposing said poles of said first m-phase group.

18. A method of reducing adverse effects of a short in a stator of a 3-phase DC automotive steering motor of a type having a permanent magnet rotor, and a wire wound stator provided with 6 poles, said method comprising the steps of:
(1) organizing said 6 poles into 2 groups of 3 poles each;
(2) detecting said short;
(3) identifying the pole wherein said short occurred;
(4) identifying the pole group of the failed pole; and
(5) terminating current flow to all poles in the pole group of the failed pole.

19. A method according to claim 18 further comprising the step of:
(6) physically placing all poles assigned to a first one of said two pole groups semi-circularly side-by-side; and
(7) physically placing all other ones of said poles diametrically opposite corresponding poles of said first one of said two pole groups.

20. A method according to claim 19 wherein said step of terminating current flows is carried out by using pulse-width-modulated signals to turn off transistors supplying current to poles in the pole group of the failed pole.

21. The method of ameliorating the effect of a short in a brushless DC induction motor having a permanent magnet rotor and M three-phase pole, groups, said method comprising the steps of:
(1) detecting the occurrence of said short;
(2) identifying a pole group in which said short occurred; and
(3) disabling all poles in said pole group, so that poles which are not members of said pole group are available for countering drag torques arising as a consequence of said short.

22. A method according to claim 21 wherein the value of M is 2.

23. A method according to claim 22 further comprising the step of operating said poles which are not members of said pole group to assist an operator in the steering of an automotive vehicle.
